(19) United States
(12) Patent Application Publication
(10) Pub. No.: US 2009/0257400 A1
(43) Pub. Date: Oct. 15, 2009

(54) METHOD AND APPARATUS FOR HANDOVER BETWEEN A NETWORK SUPPORTING PROXY MOBILE IP AND A NETWORK SUPPORTING MOBILE IP

(75) Inventor: Michelle Perras, Montreal (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/421,357

(22) Filed: Apr. 9, 2009

Related U.S. Application Data
(60) Provisional application No. 61/044,200, filed on Apr. 11, 2008.

(51) Int. Cl. H04W 36/00

(52) U.S. Cl. 370/331

(57) ABSTRACT

A method and an apparatus for supporting handover between a first network supporting proxy mobile Internet Protocol (IP) (PMIP) and a second network supporting mobile IP (MIP) are disclosed. A PMIP entity in the first network may perform home agent (HA) discovery such that the PMIP entity may select an HA that responds with a pre-determined code indicating that a binding entry for the WTRU exists in the HA. The PMIP entity may store the HA IP address in an authentication, authorization, and accounting (AAA) server. The PMIP entity may retrieve the HA IP address for the WTRU from the AAA server when the WTRU is readmitted, and perform a binding update using the HA IP address. A media independent handover (MIH) client may trigger an HA discovery to obtain an HA IP address without performing MIP registration. The MIP client may retain the HA IP address when disabled.

### CROSS REFERENCE TO RELATED APPLICATIONS

This application claims the benefit of U.S. Provisional Application No. 61/044,200, filed Apr. 11, 2008, which is incorporated by reference as if fully set forth.

### FIELD OF INVENTION

This application is related to wireless communications.

### BACKGROUND

Mobile Internet protocol version 4 (IPv4) is defined in RFC3344 “IP Mobility Support for IPv4.” The purpose of Mobile IP (MIP) is to allow transparent routing of IP datagrams to mobile nodes (MN) on the Internet. The MN is always identified by its home address. While away from a home network, the MN is associated with a care-of-address (CoA) from the visited network. A binding is created for the MN in the home agent (HA) to associate the CoA with the home address. A tunnel is established between the HA and a foreign agent (FA) in the visited network and the datagrams destined to the MN are routed from the HA to the CoA through the tunnel. The datagrams are then delivered to the MN.

Proxy MIP (PMIP) has been introduced for network-based mobility management. While MIP is a host-based mobility management protocol, in PMIP the MIP client functionality is implemented on the network. After successful authentication and authorization of the MN at the visited network, the PMIP entity in the visited network handles MIP registration with the HA. The MN is not involved in the MIP registration procedure. A CoA from the visited network is used as with MIP and a tunnel is created between the HA and the FA. The HA sends datagrams destined to the MN to the CoA through the tunnel. The datagrams are then delivered to the MN.

Since not all the networks support both MIP and PMIP, there would be problems when an MN moves from one network to another and both networks do not support the same protocol, e.g., a handover between a wideband code division multiple access (WCDMA) network that supports MIP and a wireless broadband (WiBro) network that supports PMIP.

FIGS. 1A-1D show a handover and interaction between a WiBro network and a WCDMA network. Referring to FIG. 1A, an MN makes an initial connection to the WiBro network (step 102). The WiBro network implements PMIP and an MIP client in the MN is currently disabled and no IP address has been allocated to the MN. The MN sends a dynamic host configuration protocol (DHCP) request to the WiBro network to obtain an IP address (step 104).

Triggered by the DHCP request, a PMIP entity in the WiBro network initiates an HA discovery procedure (step 106). For HA discovery, the PMIP entity broadcasts a registration request with the MN identity (ID). According to RFC3344, HAs deny registration requests that are sent to the subnet-directed broadcast address of the home network (as opposed to being unicast to the HA). HAs discard the registration request and return a registration reply with a code of 136. The registration reply contains HA's unicast address, so that the PMIP entity can re-issue the registration request with the HA's unicast address. The PMIP entity receives an IP address (i.e., home address) for the MN from the HA, and a binding is created in the HA and the CoA is registered with the home address in the HA. The home address is provided to the MN via the DHCP response (step 108).

The MIH entity in the MN may perform MIH registration with the MIH server (step 110). At this moment, the MN does not know the HA IP address and therefore the MIH server is not provided with the HA IP address.

Referring to FIG. 1B, a handover from the WiBro network to the WCDMA network occurs and the MN is now connected to the WCDMA network and a new session is established (step 112). An MIP client in the MN is enabled and the MIP client obtains a CoA from the FA in the WCDMA network (step 114). The MIP client in the MN performs HA discovery and a binding update (step 116). HA discovery has to be performed each time MIP client is enabled.

Referring to FIG. 1C, a subsequent handover to the WiBro network occurs, and the MN is now connected to the WiBro network, and the MIP client in the MN is disabled (step 118). Triggered by the MN's authentication, the PMIP entity in the WiBro network performs HA discovery and a binding update (step 120). HA discovery has to be performed each time a handover from the WCDMA network to the WiBro network occurs, because the PMIP entity handling the mobility for the MN on the WiBro network may be a different PMIP entity than the last time the MN was connected to the WiBro network. Even if the same PMIP entity is connected after the handover, since the MN went away, the PMIP entity may have deleted the MN's information.

Referring to FIG. 1D, a subsequent handover to the WCDMA network occurs, and the MN is now connected to the WCDMA network (step 122). The MIP client in the MN is enabled and obtains a CoA from the FA (step 124). The MIP client in the MN initiates a HA discovery again and performs a binding update (step 126). When the MIP client is disabled (because of handover to WiBro), the HA's IP address is lost. Therefore, HA discovery has to be performed each time a handover from the WiBro network to the WCDMA network occurs.

In the prior art, HA discovery has to be performed each time a handover from WCDMA to WiBro occurs because the PMIP entity handling the mobility on the WiBro network may be a different PMIP entity than the last time the MN was connected on the WiBro network. Even if the same PMIP entity is used after the handover, since the MN went away, the PMIP entity may have deleted the MN's information. Re-performing the HA discovery introduces delays in the handover procedure.

HA discovery also has to be performed each time a handover from WiBro to WCDMA occurs because the MIP client on the MN must discover the HA IP address when the MIP client is enabled, but when the MIP client is disabled (because of handover to WiBro), the HA's IP address is lost. Re-performing the HA discovery introduces delays in the handover procedure.

As shown in FIGS. 1A-1D, HA discovery is performed on both networks each time a handover occurs. Besides the delay, it is a problem if a different HA is selected. Using a different HA would result in a loss of connectivity with the correspondent node since the MN's IP address is allocated by the first HA.

IEEE 802.21 media independent handover (MIH) has been introduced to allow efficient software implementation of handover between different technologies (e.g., WiBro to WCDMA and vice versa) and enable automatic inter-technology mobility both at Layer 2 and Layer 3, reduced handover interruption time, and provide quality of service (QoS) optimization across different technologies. The HA IP address may be provided to the MIH server during MIH registration so that the MIH server performs data buffering during handover while the connectivity is lost. However, the HA IP address cannot be provided to the MIH server in case that the MN started up in the WiBro network because MIH registration is performed by the MIH client residing on the MN but the HA IP address is not known to the MN. Therefore, the MIH server cannot perform data buffering during handover until the HA IP address is discovered by the MIP client on the MN.

### SUMMARY

A method and an apparatus for supporting handover between a first network supporting PMIP and a second network supporting MIP are disclosed. After admitting a wireless transmit/receive unit (WTRU), a PMIP entity in the first network may send a registration request to discover an HA. The PMIP entity may select an HA that responds with a pre-determined code indicating that a binding entry for the WTRU exists in the HA and perform MIP registration with the selected HA for the WTRU. The PMIP entity may store the HA IP address in an authentication, authorization, and accounting (AAA) server. The PMIP entity may retrieve the HA IP address for the WTRU from the AAA server when the WTRU is readmitted, and perform a binding update using the HA IP address. An MIH entity in the WTRU may trigger an MIP client of the WTRU to perform an HA discovery to obtain an HA IP address without performing MIP registration, and perform an MIH registration with an MIH server to register the HA IP address. The MIP client may retain the HA IP address when disabled. The MIP client may perform a binding update with the HA using the stored HA IP address.

### BRIEF DESCRIPTION OF THE DRAWINGS

A more detailed understanding may be had from the following description, given by way of example in conjunction with the accompanying drawings wherein:

FIGS. 1A-1D show a handover procedure between a WiBro network and a WCDMA network;

FIGS. 2A-2D show an example handover procedure between a WiBro network and a WCDMA network in accordance with embodiments; and

FIG. 3 is a block diagram of an example WTRU.

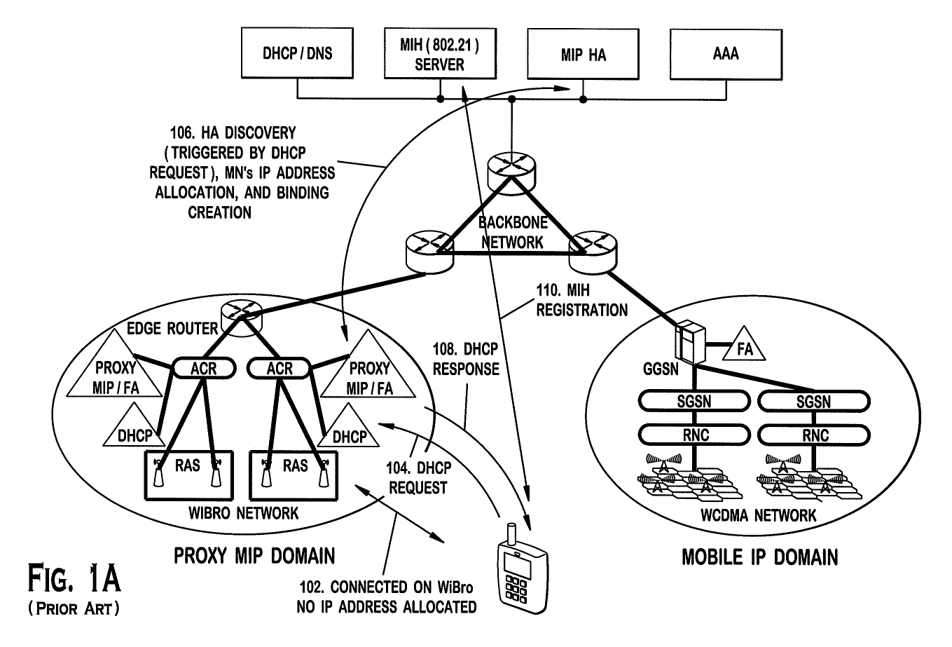

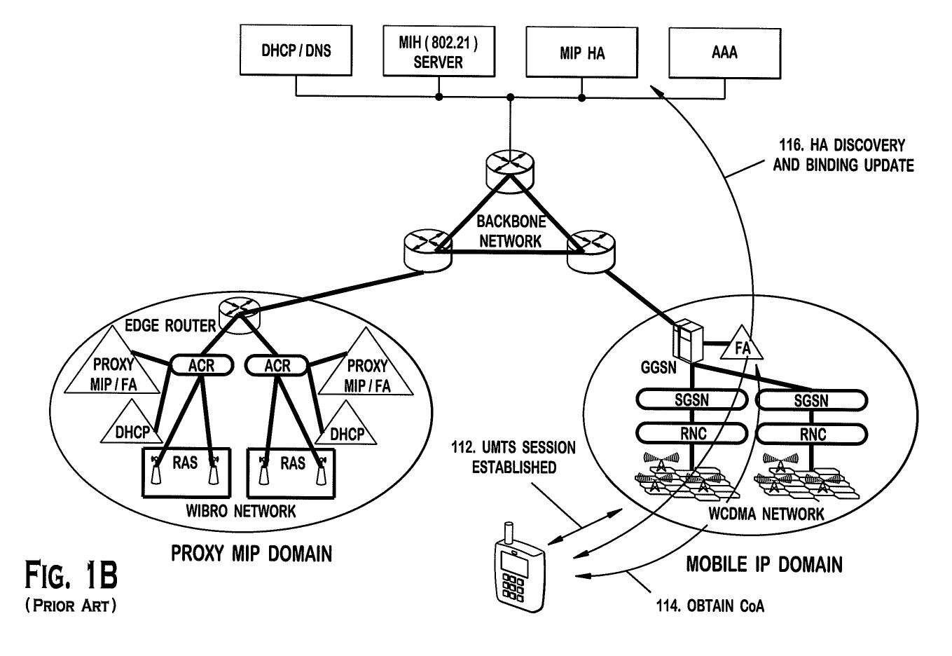

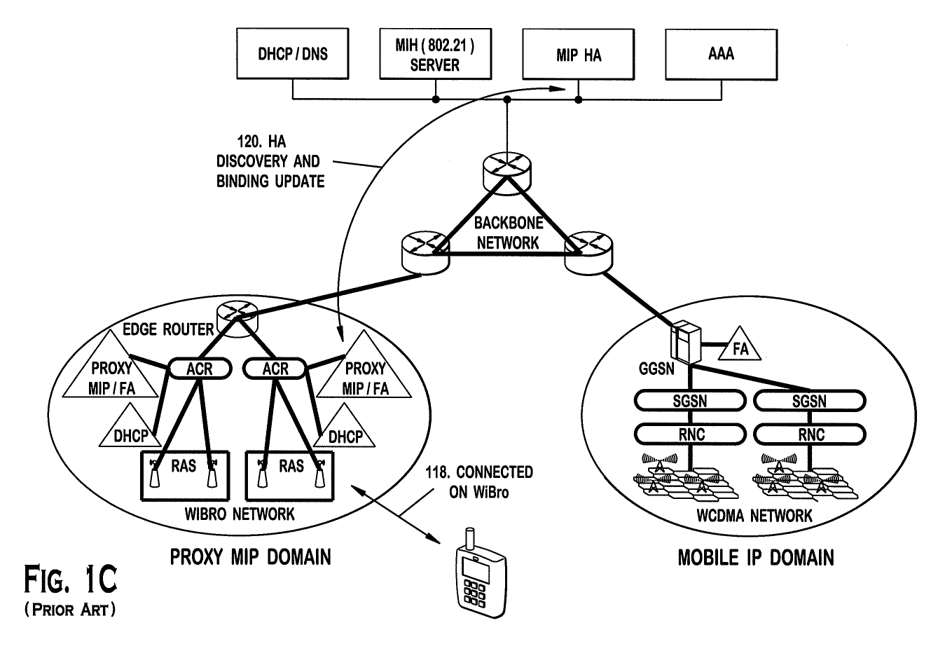

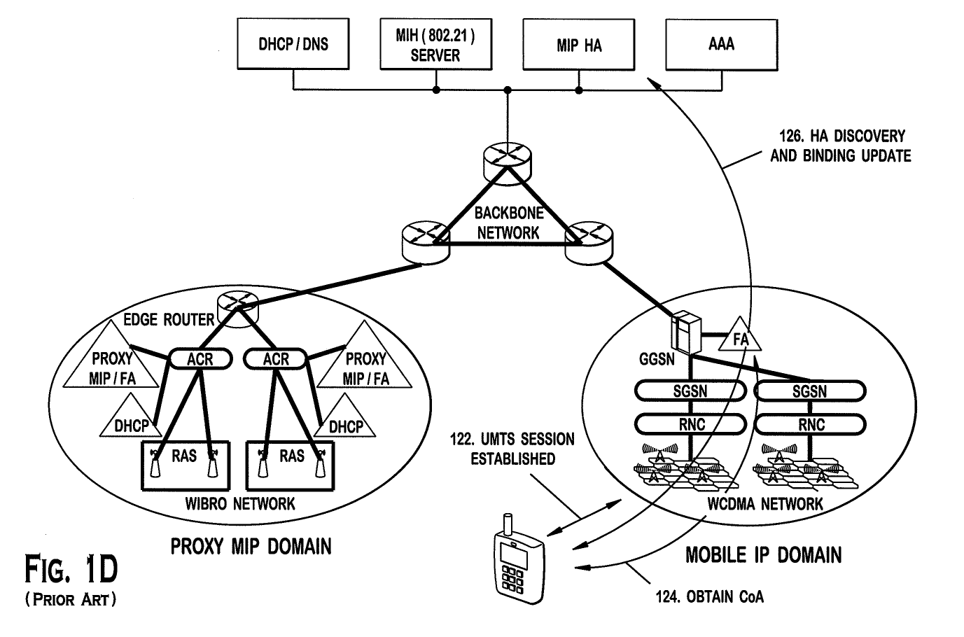

### DETAILED DESCRIPTION

When referred to hereafter, the terminology “wireless transmit/receive unit (WTRU)” includes but is not limited to a user equipment (UE), a mobile node (MN), a mobile station, a fixed or mobile subscriber unit, a pager, a cellular telephone, a personal digital assistant (PDA), a computer, or any other type of user device capable of operating in a wireless environment.

Embodiments for handover and interaction between a network supporting MIP (e.g., a WCDMA network) and a network supporting PMIP (e.g., a WiBro network) are disclosed. It should be noted that WCDMA and WiBro will be used as an example for the following description, but the embodiments disclosed herein are applicable to any types of wireless networks.

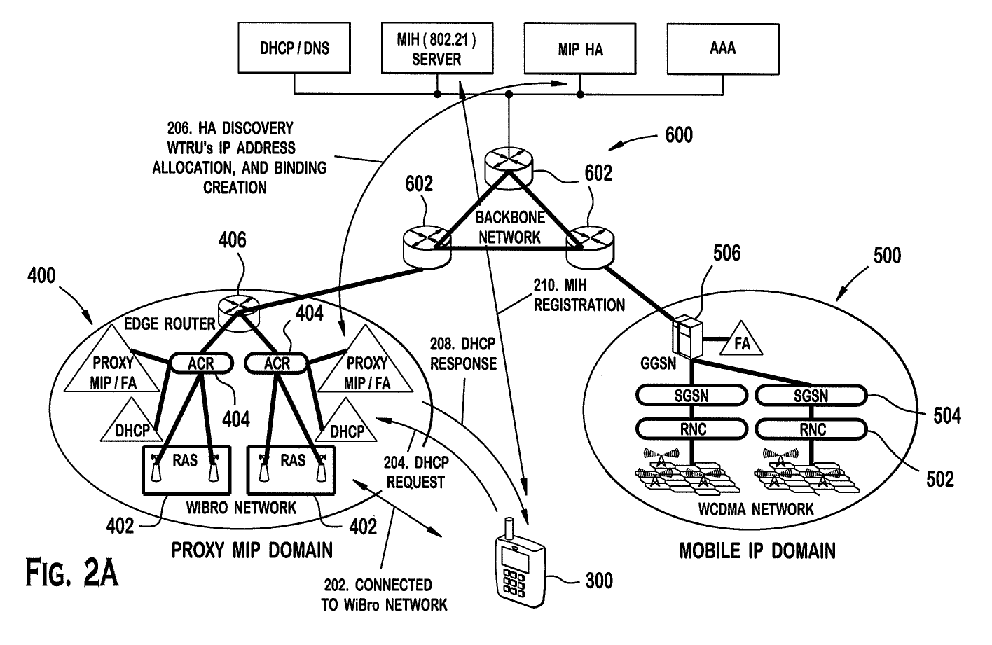

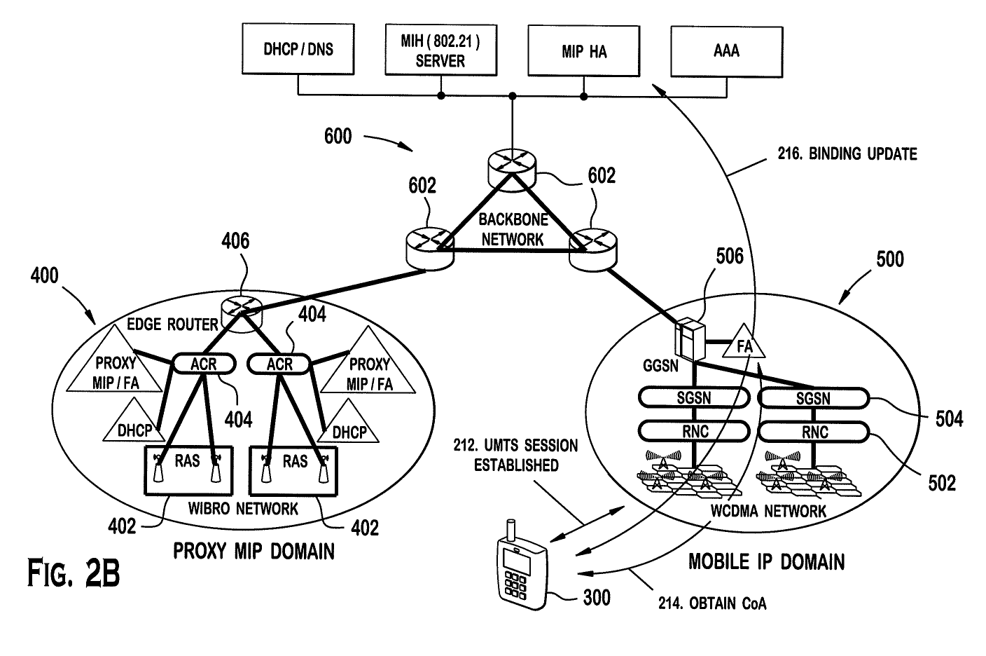

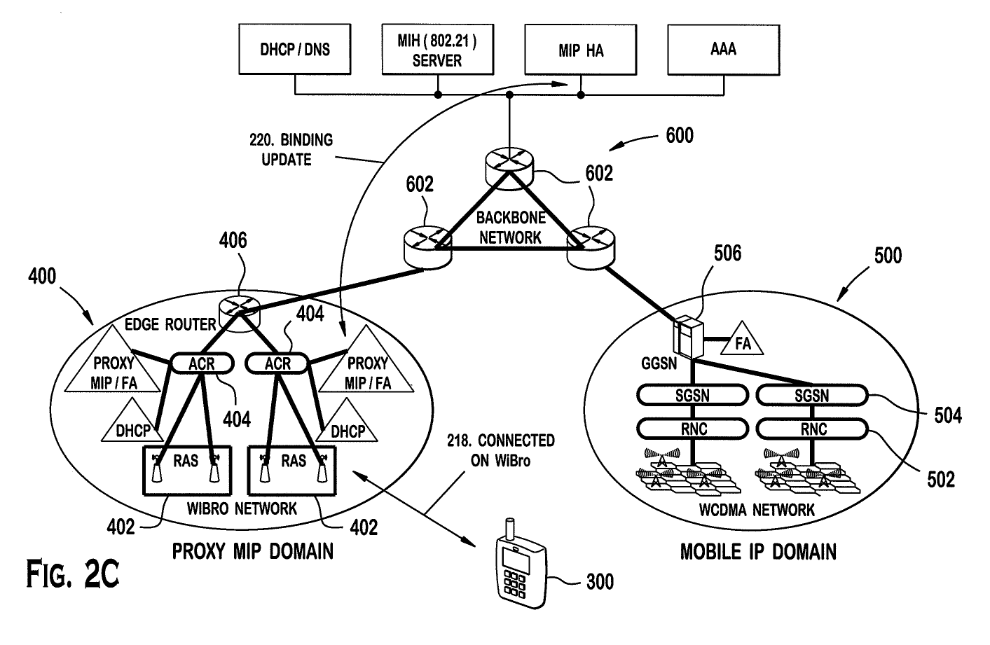

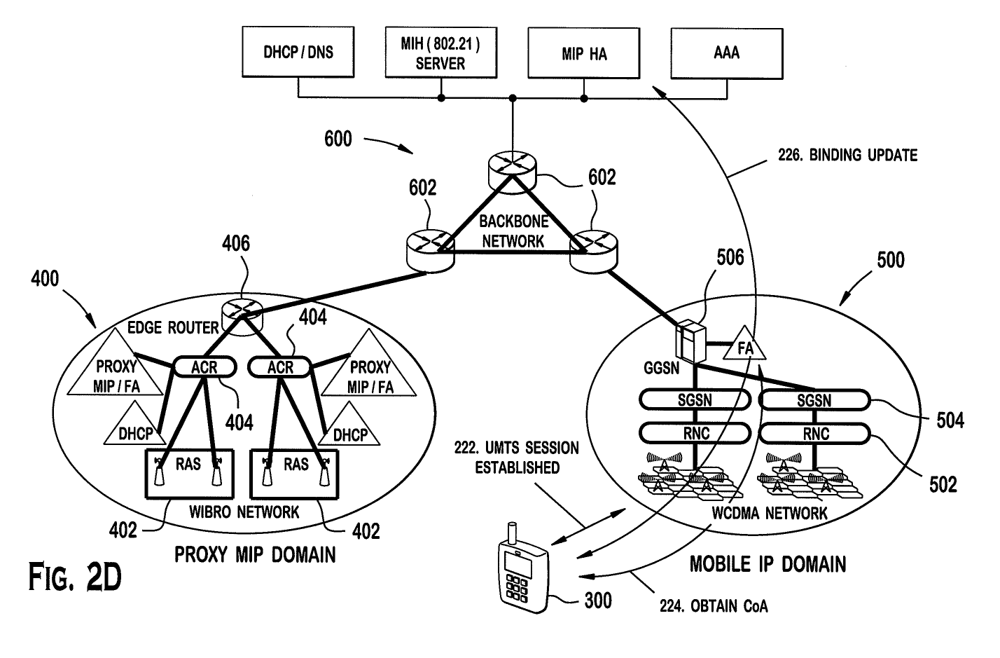

FIGS. 2A-2D show an example handover procedure between a WiBro network 400 and a WCDMA network 500 in accordance with one embodiment. The WiBro network 400 includes a radio access station 402, an access control router (ACR) 404, and an edge router 406. A PMIP entity and a DHCP entity reside in the ACR 404. The WiBro network 400 is connected to the backbone network 600 through the edge router 406. The backbone network 600 includes a plurality of routers 602 and a DHCP server, a domain name system (DNS) server, an MIH server, an MIP HA, an AAA server reside in the routers 602. The WCDMA network 500 includes a radio network controller (RNC) 502, a serving GPRS support node (SGSN) 504, and a gateway GPRS support node (GGSN) 506.

Referring to FIG. 2A, a WTRU 300 makes an initial connection to the WiBro network 400 (step 202). The WiBro network 400 implements PMIP and an MIP client in the WTRU 300 is currently disabled and no IP address is allocated to the WTRU 300. To obtain an IP address, the WTRU 300 sends a DHCP request to the WiBro network 400 (step 204). Triggered by the DHCP request, a PMIP entity in the WiBro network 400 initiates an HA discovery procedure (step 206). The PMIP entity sends a registration request with the WTRU ID. HAs deny registration requests that are sent to the subnet-directed broadcast address of the home network as opposed to being unicast to the HA.

In accordance with one embodiment, upon receiving the registration request, the HA first fetches binding entries for the WTRU 300. If the HA already has a binding entry for the WTRU 300, the HA rejects the registration request with a predetermined code (e.g., a code of 137), indicating that the request is denied by the HA but a binding entry exists. The registration reply still contains the HA's unicast IP address. If the HA does not have a binding entry for the WTRU 300, the HA rejects the request with code 136 as usual. The PMIP entity waits for all HA's to reply and chooses the HA that reports the predetermined code (e.g., code 137), if there is one. If there is no HA that rejects the registration request with the predetermined code (e.g., code 137), the PMIP entity selects one HA based on the pre-configured criteria. The PMIP entity receives an IP address for the WTRU 300 (i.e., home address) and a binding is created for the WTRU 300 in the HA such that the CoA is registered with the home address in the HA. The home address is provided to the WTRU 300 via the DHCP response (step 208).

After the HA discovery, the PMIP entity may save the HA IP address in an AAA server. When a handover is performed to the WiBro network later, the PMIP entity interrogates the AAA server to authenticate and authorize the WTRU 300. At the same time, the HA's IP address is fetched from the AAA server and made available to the PMIP entity. With this scheme, the HA discovery does not have to be re-performed by the PMIP entity, thus reducing the handover execution time.

The WTRU 300 may perform HA discovery to obtain HA IP address and performs MIH registration with the discovered HA IP address (step 210). The MIH entity in the WTRU 300 may trigger HA discovery using a new interface to the MIP client in the WTRU 300 to obtain the HA IP address. The MIP entity is currently disabled, but still active. Therefore, upon triggering by the MIH entity, the MIP entity in the WTRU 300 may perform only the HA discovery without doing MIP registration with the HA because the MIP registration with the HA has already been done by the PMIP entity on the WiBro network 400.

For the HA discovery, the MIP client broadcasts a registration request. Upon receiving the registration request, the HA first fetches binding entries for the WTRU 300. If the HA already has an entry for the WTRU 300, the HA rejects the registration request with a predetermined code (e.g., a code of 137), indicating that the request is denied by HA but a binding entry exists. The registration reply still contains the HA's unicast IP address. If the HA does not have an entry for the WTRU, the HA rejects the request with code 136 as usual. Since the initial HA registration has been performed by the PMIP entity of the WiBro network at step 206, one HA would respond with the predetermined code (e.g., code 137), indicating that the HA has a binding entry for the WTRU 300. The WTRU 300 selects that HA. With this scheme, the MIP client can select the same HA as the one selected by the PMIP entity of the WiBro network.

Once the HA discovery procedure is done, the MIH client in the WTRU 300 may query the MIP client to obtain the discovered HA IP address, and may perform MIH registration to register the HA IP address with the MIH server. With the provided HA IP address, the MIH server may perform data buffering during handover (while the connectivity is lost).

In addition, once the HA IP address has been discovered, the MIP client in the WTRU 300 may remember the HA IP address even when disabled. With this scheme, the HA discovery does not have to be re-performed when the MIP client is re-enabled.

Referring to FIG. 2B, a handover from the WiBro network 400 to a WCDMA network 500 occurs and the WTRU 300 is now connected to the WCDMA network 500, and a new session is established (step 212). The MIP client in the WTRU 300 is enabled and the MIP client obtains a CoA from the FA (i.e., GGSN 506) in the WCDMA network 500 (step 214). The MIP client in the WTRU 300 does not have to perform HA discovery again, because the MIP client knows the HA IP address through the HA discovery only procedure (step 210 from FIG. 2A) performed while the WTRU was connected to the WiBro network. With this scheme, a delay due to the subsequent HA discovery may be reduced and the possibility of selecting a different HA is eliminated. Alternatively, the MIP client may perform HA discovery again. The MIP client of the WTRU 300 performs a binding update (step 216).

Referring to FIG. 2C, a subsequent handover back to the WiBro network 400 from the WCDMA network 500 occurs. The WTRU is connected to the WiBro network 400, and the MIP client in the WTRU 300 is disabled (step 218). The PMIP entity interrogates the AAA server to authenticate and authorize the WTRU 300 and at the same time, the HA's IP address is fetched from the AAA server. Since the PMIP entity knows the HA IP address, the HA discovery does not have to be re-performed by the PMIP entity, thus reducing the handover execution time. The PMIP entity performs a binding update with the HA (step 220).

Referring to FIG. 2D, a subsequent handover from the WiBro network 400 to the WCDMA network 500 occurs. The WTRU 300 is now connected to the WCDMA network 500 and the MIP client in the WTRU 300 is enabled (step 222). The MIP client obtains a CoA from the FA (i.e., GGSN 506; step 224). Since the MIP client does not have to perform HA discovery again because the MIP client knows the HA IP address (the MIP client remembers the HA IP address even if disabled), the MIP client performs a binding update with the HA (step 226).

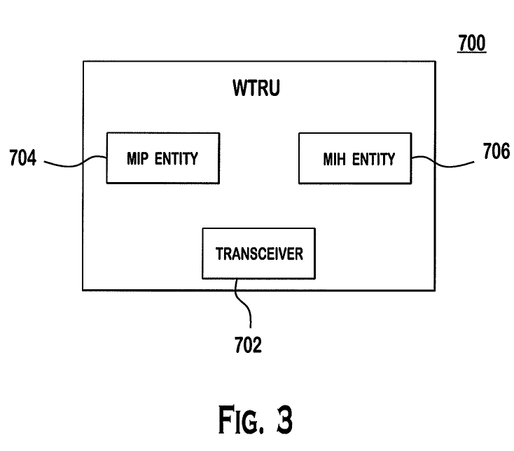

FIG. 3 is a block diagram of an example WTRU 700. The WTRU 700 includes a transceiver 702, an MIP entity 704, and an MIH entity 706. The MIP entity 704 is configured to perform MIP functionalities including an HA discovery to obtain an HA IP address. The MIH entity 706 is configured to perform MIH functionalities including triggering the MIP entity to perform an HA discovery to obtain an HA IP address without performing MIP registration with the HA, and performing an MIH registration with an MIH server to register the HA IP address. The MIP entity 704 may be configured to retain the HA IP address when disabled and perform a binding update with the HA using the HA IP address. The MIP entity 704 may be configured to send a registration request, and select an HA that responds with a pre-determined code indicating that a binding entry for the WTRU exists in the HA.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for handover between a first network supporting proxy mobile Internet Protocol (IP) (PMIP) and a second network supporting mobile IP (MIP), the method comprising:
the first network admitting a wireless transmit/receive unit (WTRU);
a PMIP entity in the first network sending a registration request to discover a home agent (HA);
the PMIP entity selecting an HA that responds with a pre-determined code indicating that a binding entry for the WTRU exists in the HA; and
the PMIP entity performing MIP registration with the selected HA for the WTRU.

2. The method of claim 1 further comprising:
the PMIP entity storing an HA IP address in an authentication, authorization, and accounting (AAA) server.

3. The method of claim 2 further comprising:
the first network re-admitting the WTRU;
the PMIP entity retrieving the HA IP address for the WTRU from the AAA server; and
the PMIP entity performing a binding update using the HA IP address.

4. A method for handover between a first network supporting proxy mobile Internet Protocol (IP) (PMIP) and a second network supporting mobile IP (MIP), the method comprising:
a wireless transmit/receive unit (WTRU) connecting to the first network;
the WTRU obtaining an MIP home address;
a media independent handover (MIH) client in the WTRU triggering an MIP client of the WTRU to perform a home agent (HA) discovery to obtain an HA IP address without performing MIP registration with the HA; and
the MIH client performing an MIH registration with an MIH server to register the HA IP address.

5. The method of claim 4 wherein the MIP client of the WTRU retains the HA IP address when disabled.

6. The method of claim 5 further comprising:
the WTRU performing a handover to the second network;
the MIP client obtaining a care of address (CoA) from the second network; and
the MIP client performing a binding update with the HA using the HA IP address.

7. The method of claim 5 wherein the HA discovery includes:
the MIP client sending a registration request; and
the MIP client selecting an HA that responds with a pre-determined code indicating that a binding entry for the WTRU exists in the HA.

8. An apparatus for supporting a handover, comprising:
an admission controller configured to admit a wireless transmit/receive unit (WTRU); and
a proxy mobile Internet Protocol (IP) (PMIP) entity configured to send a registration request to discover a home agent (HA), select an HA that responds with a pre-determined code indicating that a binding entry for the WTRU exists in the HA, and perform MIP registration with the selected HA for the WTRU.

9. The apparatus of claim 8 wherein the PMIP entity is configured to store an HA IP address in an authentication, authorization, and accounting (AAA) server.

10. The apparatus of claim 8 wherein the PMIP entity is configured to retrieve the HA IP address for the WTRU from the AAA server when the WTRU is readmitted, and perform a binding update using the HA IP address.

11. A wireless transmit/receive unit (WTRU), comprising:
a transceiver;
a mobile IP (MIP) entity configured to perform a home agent (HA) discovery to obtain an HA IP address; and
a media independent handover (MIH) entity configured to trigger the MIP entity to perform an HA discovery to obtain an HA IP address without performing MIP registration with the HA, and perform an MIH registration with an MIH server to register the HA IP address.

12. The WTRU of claim 11 wherein the MIP entity is configured to retain the HA IP address when disabled.

13. The WTRU of claim 12 wherein the MIP entity is configured to obtain a care of address (CoA) from a second network, and perform a binding update with the HA using the HA IP address.

14. The WTRU of claim 12 wherein the MIP entity is configured to send a registration request, and select an HA that responds with a pre-determined code indicating that a binding entry for the WTRU exists in the HA.
